(19) United States
(12) Patent Application Publication
(10) Pub. No.: US 2004/0218165 A1
(43) Pub. Date: Nov. 4, 2004

(54) Method and apparatus for projecting image information onto a light sensitive material

(75) Inventors: Ulrich Kluter, Munich (DE); Thomas Hartmann, Uffing/Staffelsee (DE)

Correspondence Address: DARBY & DARBY P.C., P. O. BOX 5257, NEW YORK, NY, 10150-5257, US

(73) Assignee: AGFA-GEVAERT AKTIENGESELLSCHAFT, Leverkusen (DE)

(21) Appl. No.: 10/786,882

(22) Filed: Feb. 24, 2004

(30) Foreign Application Priority Data
Feb. 28, 2003 (EP) 03100515.0

(51) Int. Cl. G03B 27/72

(52) U.S. Cl. 355/69; 355/71; 355/67; 355/53

(57) ABSTRACT

An image in the form of image dots produced by one or more pixel generators is projected onto a light-sensitive material with a certain amount of light power over a certain length of exposure time. Each pixel generator is driven by a voltage of periodically alternating polarity which alternates between half-periods of negative voltage and half-periods of positive voltage, with the negative voltage and the positive voltage being equal in absolute magnitude. The exposure time for each image dot is allocated equally to the respective half-periods of negative and positive voltage.

### BACKGROUND OF THE INVENTION

The invention relates to a method and an apparatus for projecting information in the form of images onto a light-sensitive material. The images are composed of pixel dots produced by pixel-generating devices. The image dots are projected onto the light-sensitive material with a specific amount of light power over the duration of a specific exposure time. Each pixel-generating device is driven by a voltage that alternates between positive and negative polarity in a periodic cycle. The respective time intervals of positive and negative voltage are of the same length, i.e., each is equal to one-half of the period length, and the positive and negative voltages have the same absolute magnitude.

The field of conventional photography which is based on silver halogenide film is more and more being expanded or even supplanted by electronic technology. This applies to the front end of the process, i.e., taking pictures with a camera, as well as to the subsequent processing of the film. For example, modern cameras have the standard feature that they can record additional information on the film, such as the exposure date, greeting messages or other information relating to each individual picture. In connection with this concept, it has also been known for some time to provide photographic films with a magnetic recording layer on which the camera stores information that is used in subsequent processing steps of the film. A film and a processing method according to this concept have been disclosed, e.g., in U.S. Pat. No. 5,029,313.

Furthermore, it is often found desirable to add information such as greeting messages to the photo prints, either on the picture itself or next to the picture, during the later processing steps, i.e., after producing the photo prints from the developed film. With increasing frequency, it is also found desirable to print images of photographic quality directly from an electronic image source—e.g., an electronic storage memory of the kind used in digital cameras, a computer, or a scanner—onto a photographic material.

All of the aforementioned requirements can be met by an apparatus that projects digital image data onto a light-sensitive exposure material. An apparatus that performs this function by generating images with a liquid crystal display (LCD) is disclosed in WO 02/02342 A1. The LCD is arranged in a projection light path with an optical objective and a light source that delivers light in a plurality of different colors. The image components of the different colors are sequentially generated in the LCD and each of the image components is projected with light of the respective color onto the photographic paper.

An LCD consists of two electrodes separated by a very thin layer of the liquid crystal. If a certain voltage is applied to the electrodes for an extended time period, it is possible that an electrolysis process will take place in the LCD. This affects the properties of the liquid crystal, so that the response of the liquid crystal when a voltage of a given magnitude is applied will no longer be reproducible. To prevent this problem, LCDs of the kind mentioned above are now driven with an alternating voltage. The fast alternation of the voltage polarity reliably prevents electrolysis effects from occurring.

It has however been found that the optical properties of a liquid crystal depend on the voltage polarity, so that the effect on the light in the projection light path when a negative voltage is applied is not the same as when a positive voltage is applied. In practice, the difference is insignificant if the exposure time is long in comparison to the period of alternation of the applied voltage, but it becomes a factor if the exposure time is of the order of only a few alternation periods of the applied voltage.

### OBJECT OF THE INVENTION

The present invention therefore has the objective to provide a method and an apparatus for projecting image information onto a light-sensitive material, where the differences due to the alternating polarity of the driving voltage are compensated and the exposure is controlled in such a manner that an alternating voltage can be used without negatively affecting the reproducibility of the results.

### SUMMARY OF THE INVENTION

To solve the problem just stated, the invention proposes a method and an apparatus for projecting information in the form of images onto a light-sensitive material. The images are composed of image dots produced by one or more pixel-generating devices. The image dots are projected onto the light-sensitive material with a specific amount of light power over the duration of a specific exposure time. Each pixel-generating device is driven by a voltage that alternates in a periodic cycle between a negative voltage of a specific magnitude over one half-period and a positive voltage of equal absolute magnitude over the next half-period. As a specific feature of the invention, the exposure time for each image dot is allocated equally to the respective half-periods of positive and negative voltage polarity.

The inventive concept of allocating the required exposure time equally to half-periods of negative driving voltage (negative half-periods) and half-periods of positive driving voltage (positive half-periods) ensures that for each exposure, the amount of time in which the voltage is positive equals the amount of time in which the voltage is negative. Thus, the different properties of the LCDs in the respective half-periods of positive and negative driving voltage compensate each other, regardless of how large the differences are.

The correct exposure of a light-sensitive material to projected image information is in principle a function of light power and exposure time. In one embodiment of the invention, the exposure time is selected as an integer multiple of the period length, i.e., of the time interval consisting of one negative half-period and one positive half-period of the driving voltage. The light power is appropriately matched to the exposure time. Controlling the exposure time in this manner ensures that the LCD always receives equal numbers of positive and negative half-periods of the applied alternating voltage in every exposure.

In a further embodiment of the invention, the correct exposure is achieved not by adjusting the light power, but by adjusting the period length of the applied alternating voltage. This allows the light power and the exposure time to be set without any constraint imposed by a fixed period length. One only has to adjust the applied alternating voltage so that the exposure time is again an integer multiple of the period length.

Another preferred embodiment of the invention likewise provides an independent selection of exposure time and light power independent of constraints imposed by the driving voltage, but without the requirement to adjust the frequency of the driving voltage. The correct exposure is achieved in this case by interrupting the exposure at some arbitrary point. For example, if it was determined that the required exposure time is two and a half times the period length, and if the exposure is started at the beginning of a negative half-period, the interruption can occur after the negative half-period, the subsequent positive half-period and one half of the following negative half-period have elapsed. The exposure time up to this point amounts to one and a half negative half-periods and one positive half-period. The exposure can be restarted after the second half of the negative half-period and half of the subsequent positive half-period have elapsed. This second part of the exposure would fill the second half of the positive half-period and the immediately following negative half-period as well as the subsequent positive half-period. Thus, the second exposure time segment will have covered one and a half positive half-periods and one negative half-period, so that the combined exposure time over the first and second time segments conforms to the previously determined exposure time of two and a half times the period length allocated equally to half-periods of negative and positive voltage polarity.

In an exposure according to the preceding embodiment, the exposure is preferably not interrupted until two positive half-periods and two and a half negative half-periods have elapsed. After an exposure break of one half of a negative half-period, the exposure is resumed for another half of a positive half-period and then terminated. With this exposure pattern, the break in the exposure lasts only one half of a half-period, so that the total time required for the exposure is minimized.

LED light sources (light emitting diodes) in particular are subject to temperature-dependent variations. One can therefore not rely on the assumption that equal exposure times will always result in equal amounts of light energy being projected onto the light-sensitive material. According to the invention, the light power of the light source is therefore continuously measured, and the initially determined exposure time is appropriately corrected even during the current exposure. In the first of the foregoing embodiments, where the light power is controlled, the light power is regulated to a changed target value during the exposure. In the second embodiment, where the frequency of the alternating voltage is controlled, the frequency needs to be adjusted if a change in the light power occurs during the exposure.

The preferred way of measuring the light power is by means of an intensity/frequency converter. Sensors of this kind use a photodiode in combination with a current/frequency converter. The output signal of the sensor consists of identical voltage pulses following each other at intervals whose length depends on the measured light intensity. Thus, the output signal of the intensity/frequency converter has a pulse frequency that is in proportion to the light power generated by the light source.

According to a particularly preferred embodiment of the invention, the amount of light required for an exposure is defined in terms of a number of output pulses of the intensity/frequency converter. The number of pulses is allocated equally to negative and positive half-periods of the LCD driver voltage. During an exposure, two running down-counts are performed in which the pulse count during half-periods of positive voltage is subtracted from the starting number that was allocated to positive half-periods, and the pulse count during half-periods of negative voltage is subtracted from the starting number that was allocated to negative half-periods. As soon as one of the down-counts has reached zero, the exposure is interrupted until the start of the next driver-voltage half-period. During this next half-period, the other down-count will also reach zero, so that the exposure can be terminated. This concept ensures that the exposure time is allocated equally to the half-periods of negative and positive driver voltage, even if the light power varies during the exposure.

Of course, the preceding embodiment likewise has the flexibility that the break in the exposure can be inserted at a different point. It is only necessary to ensure that the output pulses of the intensity/frequency converter are directed to two separate down-counters for the respective half-periods of negative and positive driver voltage. It should also be noted that the exposure does not necessarily have to be started at the beginning of a half-period. This applies to all of the foregoing embodiments.

### BRIEF DESCRIPTION OF THE DRAWINGS

Further features and advantages of the invention will be disclosed in the following description of preferred embodiments and examples of applications with references to the attached drawings, wherein

FIG. 1 gives a schematic representation of an apparatus according to the invention;

FIG. 2 represents a graph of the LCD driver voltage in correlation with the exposure timing; and

FIG. 3 represents a block schematic of an intensity/frequency converter.

### DETAILED DESCRIPTION OF PREFERRED EMBODIMENTS

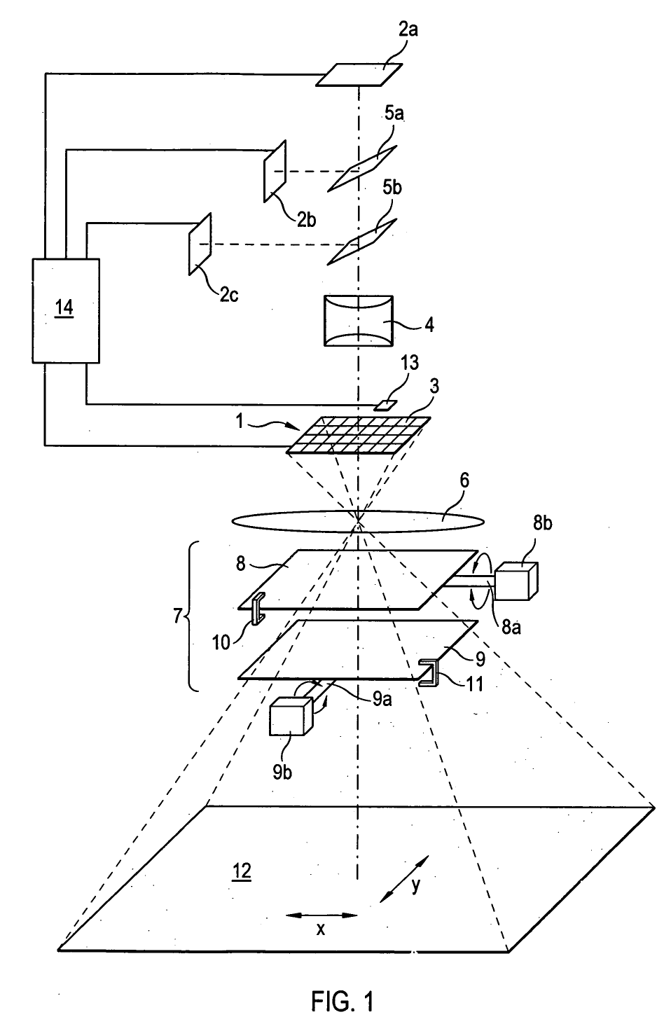

FIG. 1 illustrates in a partially perspective representation the arrangement of the optical imaging system that is used to form an image of an LCD representation on a light-sensitive material. The optical axis of the system is represented by a dash-dotted line.

The LCD 1 generates an object pattern which is illuminated by a light source 2, 5. The pattern on the LCD 1 is generated through individual LCD elements 3 (also referred to as pixel generators 3), each of which can be turned on and off individually. Each of the elements is partially covered by a mask. To achieve a four times finer resolution of the image in comparison to the object pattern generated by the LCD 1, three fourths of each LCD element 3 are covered by the mask.

The light of the light source 2, 5 is made parallel by the condenser 4, so that the LCD can be illuminated with hard light.

The colored light required for the image is generated by light-emitting diodes (LEDs). It is irrelevant whether one LED array with mixed colors is used or the light of several separate arrays of different colors is brought together in the light path of the apparatus. In the example of FIG. 1, three LED arrays 2a, 2b, 2c are used to generate, respectively, red, green and blue light. By means of the mirrors 5a and 5b, the light emitted by the LED arrays is brought together into one light path. The LED arrays of the different colors 2a, 2b, 2c, can be selectively turned on and off by the control device 14.

Also arranged in the light path of the apparatus is an intensity/frequency converter 13 which is connected to the control device 14. The pulse frequency of the output signal which the intensity/frequency converter 13 sends to the control device 14 is in proportion to the detected light power.

The LCD 1 is likewise connected to and controlled by the control device 14. An image of the object pattern generated by the LCD 1 is projected onto the photographic paper 12 through the optical projection system 6.

Arranged in the light path between the optical projection system 6 and the image plane is a mechanism 7 which serves to laterally transpose the images of the LCD elements 3.

The mechanism 7 includes two planar-parallel glass plates 8 and 9 whose tilt angles are adjustable. The glass plates are arranged following each other in the light path between the optical projection system 6 and the image plane where the light-sensitive surface of the photographic paper is located.

The glass plates 8 and 9 cause a parallel transposition of the light path by an amount that depends on the tilt angle of each of the glass plates 8 and 9. This has the effect that the image of each LCD element 3 can be moved in the plane of the photographic paper 12 in any direction and by a distance that is freely selectable within a considerable range. The transposition of the light path is controlled by tilting the two planar-parallel glass plates 8 and 9. Tilting of the glass plate 8 transposes the light path in the y-direction, and tilting of the glass plate 9 transposes the light path in the x-direction. Consequently, a transposition of the light path in any prescribed direction and by a prescribed distance can be realized through an appropriate combination of tilt angles of the two glass plates.

The two glass plates 8 and 9 are rotatably supported and equipped with drive mechanisms 8b and 9b to actuate the rotation of the glass plates 8 and 9 about their respective tilt axes 8a and 9a.

The elements of the LCD 1 have rectangular surfaces, and the tilt axes 8a and 9a are arranged in parallel alignment with the base lines of the LCD elements 3, i.e., at a right angle to each other. Thus, the tilt axes 8a and 9a lie in parallel planes that are intersected at a right angle by the optical axis of the light path. Furthermore, the tilt axes themselves intersect the optical axis.

The tilt angles of the optical elements 8 and 9 are defined by pairs of stops 10 and 11. The angle delimited by the stops is between 1° and 10°, depending on other factors of the arrangement.

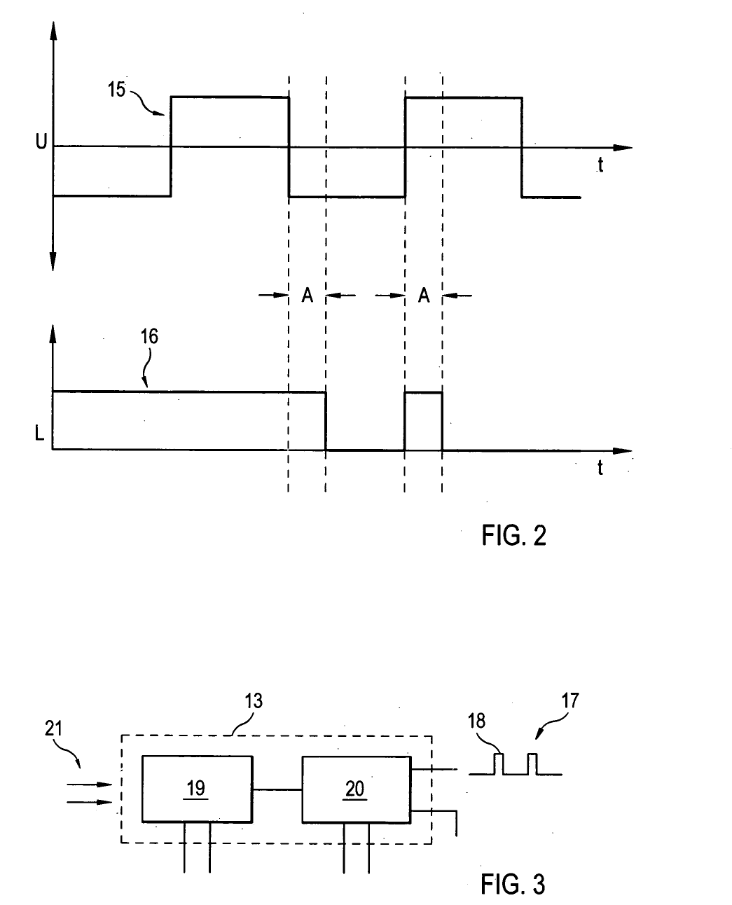

FIG. 2 illustrates the time profile of the driver voltage for the LCD 1 in correlation with the time graph of the light power. The driver voltage is identified by the reference symbol 15, and the light power is identified by the symbol 16.

A required exposure time of about 1.3 full periods is assumed in the illustrated example, where the term “full period” means the combined time interval for a negative and a positive half-period. The exposure is started at the beginning of a negative half-period and extends over that negative half-period, the subsequent positive half-period, and a portion A of the next following negative half-period, at which point the exposure is interrupted. The portion A equals 0.3 period lengths. At the beginning of the next following positive half-period, the exposure is resumed for the duration of 0.3 period lengths and then terminated. The interval A at the end of the exposure which falls on a positive half-period is of exactly equal length as the portion A of the preceding negative half-period.

FIG. 3 represents the principal arrangement of an intensity/frequency converter. The light 21 falls on the photodiode 19. The output signal of the photodiode is converted into individual pulses 18 in the pulse converter 20. Consequently, the pulse frequency of the output signal 17 of the intensity/frequency converter 13 is directly dependent on the light power of the light source 2, 5.

Prior to starting the exposure, the required amount of light is determined by a procedure which is not described in the present context. The result of the determination can be converted directly into a number of pulses 18 of the output signal 17 of the intensity/frequency converter 13. A value equal to one-half of this number is stored in each of two memory locations of the control device 14, with one memory (referred to as the negative memory) being allocated to the half-periods of negative driver voltage and the other memory (referred to as the positive memory) to the half-periods of positive driver voltage.

As soon as the exposure process begins (e.g., at the beginning of a negative half-period of the driver voltage, as in the case of FIG. 20), a counter in the control device 14 starts to count the pulses 18 of the output signal 17. The pulse count is subtracted from the number stored in the negative memory. At the beginning of a positive half-period, the counter switches over and subtracts the pulse count from the number in the positive memory.

In the example of FIG. 2, the negative count memory has been decremented to zero at some point in the second negative half-period. This is the point at which the exposure is interrupted. At the beginning of the next positive half-period, the exposure is resumed until the positive count memory, too, has been decremented to zero, at which point the exposure is terminated.

In order to achieve a high resolution of the image produced on the photographic paper, the image is composed of four partial images in each of the three colors. Accordingly, the exposure process of the foregoing description is performed twelve times for each complete image.

What is claimed is:

1. A method for projecting information in image form onto a light-sensitive material, wherein said information is composed of image dots produced by at least one pixel-generating device and said image dots are projected onto the light-sensitive material with a specific amount of light power over a specific length of exposure time, the method comprising the steps of:
driving the at least one pixel-generating device with a voltage of periodically alternating polarity which alternates between half-periods of negative voltage and half-periods of positive voltage, wherein said negative and positive voltages are equal in absolute magnitude, and wherein one each of the respective half-periods of negative and positive voltage add up to a full period having a period length; and
allocating said exposure time for each image dot equally to the respective half-periods of negative and positive voltage.

2. The method of claim 1, wherein said specific amount of light power is selected so that the exposure time is an integer multiple of said period length.

3. The method of claim 1, wherein the period length is selected so that the exposure time is an integer multiple of said period length.

4. The method of claim 1, wherein the exposure time is subdivided into at least two partial exposure time intervals which are separated by at least one exposure time break.

5. The method of claim 4, wherein the at least one exposure time break begins within one of said half-periods and ends at a next-following zero-crossing of said alternating voltage.

6. The method of claim 4, wherein a magnitude of the light power is measured during the exposure time and wherein at least one of the light power, the exposure time, and the period length is adjusted based on said measured magnitude.

7. The method of claim 6, wherein an intensity/frequency converter is used for said measuring of the light power, and wherein the intensity/frequency converter delivers an output signal consisting of countable pulses following each other with a frequency that represents a measure for the light power.

8. The method of claim 7, wherein the specific amount of light power over the specific exposure time corresponds to a quantity of light and wherein said quantity of light corresponds to a certain number of said pulses, wherein said certain number is divided into two halves, wherein a first half of the pulses is allocated to the half-periods of negative voltage and a second half of the pulses is allocated to the half-periods of positive voltage, and wherein the pulses in the output signal of the intensity/frequency converter are counted down from the first half during the half-periods of negative voltage and counted down from the second half during the half-periods of positive voltage

9. The method of claim 8, wherein the at least one exposure time break is started if one of said down-counts has reached zero before a current half-period of the alternating voltage has ended, and the projection of the image dots onto the light-sensitive material is resumed at a next-following zero-crossing of said alternating voltage.

10. The method of claim 9, wherein the projection of the image dots onto the light-sensitive material is terminated when both of said down-counts have reached zero.

11. An apparatus for projecting information in image form onto a light-sensitive material, said information being composed of image dots, wherein the apparatus comprises:
at least one pixel-generating device for producing said image dots,
a light source for projecting said image dots with a specific amount of light power over a specific length of exposure time onto the light-sensitive material;
a control device which drives the at least one pixel-generating device with a voltage of periodically alternating polarity which alternates between half-periods of negative voltage and half-periods of positive voltage, wherein said negative and positive voltages are equal in absolute magnitude, and wherein one each of the respective half-periods of negative and positive voltage add up to a full period having a period length;
wherein the control device is configured to switch the light source on and off in such a manner that said exposure time for each image dot is allocated equally to the respective half-periods of negative and positive voltage.

12. The apparatus of claim 11, further comprising an LCD array with a plurality of pixel generators arranged in rows and columns.

13. The apparatus of claim 12, wherein the light source comprises a plurality of light-emitting diodes of different colors, and wherein said light-emitting diodes are individually controllable.

14. The apparatus of claim 13, wherein the apparatus further comprises a sensor for measuring said light power.

15. The apparatus of claim 14, wherein the sensor comprises an intensity/frequency converter.

16. The apparatus of claim 15, wherein the intensity/frequency converter delivers an output signal consisting of countable pulses and wherein the apparatus further comprises a counter for counting said pulses.
